(19) United States
(12) Patent Application Publication
(10) Pub. No.: US 2016/0266960 A1
(43) Pub. Date: Sep. 15, 2016

(54) INFORMATION PROCESSING APPARATUS AND KERNEL DUMP METHOD

(71) Applicant: FUJITSU LIMITED, Kawasaki-shi (JP)

(72) Inventors: Jun MOROO, Isehara (JP); Kazushige Saga, Taito (JP)

(73) Assignee: FUJITSU LIMITED, Kawasaki-shi (JP)

(21) Appl. No.: 15/019,310

(22) Filed: Feb. 9, 2016

(30) Foreign Application Priority Data
Mar. 11, 2015 (JP) 2015-047972

(51) Int. Cl. G06F 11/07

(52) U.S. Cl. CPC G06F 11/0778; G06F 11/0721; G06F 11/0751

(57) ABSTRACT

An information processing apparatus includes a storage device; and a processing unit coupled to the storage device and configured to: execute a first kernel and, after occurrence of a failure in the first kernel, a second kernel to output a kernel dump of first data stored in the storage device to another device; and through the second kernel, using a first storage area in the storage device, output a kernel dump of second data stored in a second storage area in the storage device to the other device, and then, using the first storage area and the second storage area, output a kernel dump of third data stored in a third storage area in the storage device to the other device.

### CROSS-REFERENCE TO RELATED APPLICATION

This application is based upon and claims the benefit of priority of the prior Japanese Patent Application No. 2015-047972, filed on Mar. 11, 2015, the entire contents of which are incorporated herein by reference.

### FIELD

The embodiment discussed herein is related to an information processing apparatus and a kernel dump method.

### BACKGROUND

In an operating system running in an information processing apparatus, a failure occurs in some cases. After the occurrence of a failure, the administrator analyzes the cause of the failure. For the sake of analysis performed by the administrator, after the occurrence of a failure, the operating system outputs data stored in memory in the information processing apparatus to a device specified in advance (also called kernel dumping).

To perform such kernel dumping, the information processing apparatus executes a second kernel, in addition to a first kernel that is an operating system executed in regular operations. The second kernel is in charge of such kernel dumping.

Japanese Laid-open Patent Publication No. 2005-301639 and Japanese Laid-open Patent Publication No. 2006-172100 are examples of the related art.

The area of memory to be used for running of the second kernel (hereinafter referred to as a second kernel area, when applicable) is predetermined. The second kernel performs kernel dumping, using part of the second kernel area.

The first kernel sets the second kernel area such that the second kernel area is not available for programs other than the second kernel. This setting puts a strain on the area of memory available for programs other than the second kernel.

To avoid putting such a strain on the area of memory, the second kernel area is reduced in order to increase the area of memory available for programs other than the second kernel. Unfortunately, as the second kernel area becomes smaller, the area of memory used when the second kernel performs kernel dumping becomes smaller. As a result, it takes a long time for kernel dumping to be completed. That is, a reduction in the second kernel area leads to a decrease in the speed at which kernel dumping is performed.

In one aspect, an object of the present disclosure is to perform kernel dumping at high speed.

### SUMMARY

According to an aspect of the embodiments, an information processing apparatus includes a storage device; and a processing unit coupled to the storage device and configured to: execute a first kernel and, after occurrence of a failure in the first kernel, a second kernel to output a kernel dump of first data stored in the storage device to another device; and through the second kernel, using a first storage area in the storage device, output a kernel dump of second data stored in a second storage area in the storage device to the other device, and then, using the first storage area and the second storage area, output a kernel dump of third data stored in a third storage area in the storage device to the other device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing system including compute nodes of the present embodiment;

FIG. 2 is a hardware block diagram of a compute node of the present embodiment;

FIG. 3 is a software block diagram for explaining a program illustrated in FIG. 2;

FIG. 4 is a first diagram schematically illustrating memory areas of a random access memory (RAM) illustrated in FIG. 2;

FIG. 5A and FIG. 5B depict examples of configuration files containing information specifying areas of the RAM that are available for a second kernel illustrated in FIG. 3;

FIG. 6 is a flow diagram for explaining starting of an operating system and execution of jobs;

FIG. 7 is a second diagram schematically illustrating memory areas of the RAM illustrated in FIG. 2; and

FIG. 8 is a flow diagram for explaining kernel dumping in the present embodiment.

### DESCRIPTION OF EMBODIMENT

(System Configuration Diagram)

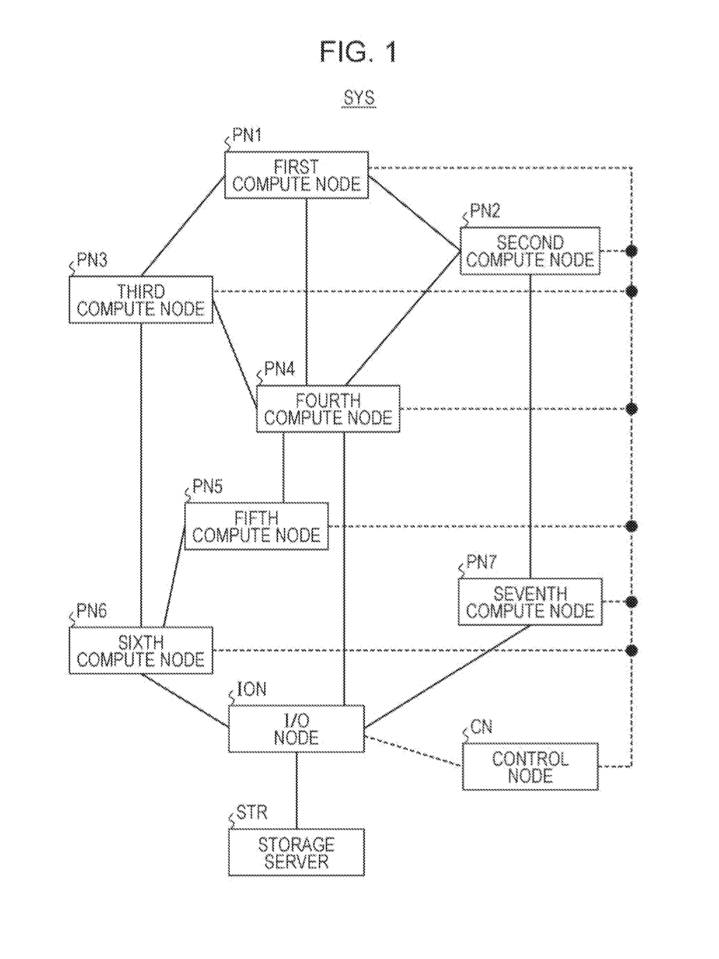

FIG. 1 is a configuration diagram of an information processing system SYS including compute nodes of the present embodiment. The information processing system SYS is a system that executes high-performance computing (HPC). Note that the information processing system is also called a computer system.

The information processing system SYS includes first compute node PN1 to seventh compute node PN7, an input-output (I/O) node ION, a control node CN, and a storage server STR. The compute node is also called an information processing apparatus. Note that, in the description of drawings given below, the same elements are denoted by the same reference letters and the description given once is omitted.

The first compute node PN1 to the seventh compute node PN7 execute jobs and output execution results of the jobs. Note that the job is, for example, a unit of work given by a person to a computer.

The control node CN executes a process of submitting jobs to the compute nodes (PN1 to PN7), control of power of the compute nodes (PN1 to PN7) and the I/O node ION, and management of the compute nodes (PN1 to PN7) and the I/O node ION.

The I/O node ION controls input and output processing of the compute nodes (PN1 to PN7) and the storage server STR. The storage server STR is a server that stores large amounts of data. The storage server STR is, for example, a server that stores images for booting the compute nodes (PN1 to PN7) and results of memory dumping.

Next, the connection relationships among nodes will be described. The first compute node PN1 is connected to the second compute node PN2 to the fourth compute node PN4. The second compute node PN2 is connected to the first compute node PN1, the fourth compute node PN4, and the seventh compute node PN7. The third compute node PN3 is connected to the first compute node PN1, the fourth compute node PN4, and the sixth compute node PN6.

The fourth compute node PN4 is connected to the first compute node PN1 to the third compute node PN3, the fifth compute node PN5, and the I/O node ION. The fifth compute node PN5 is connected to the fourth compute node PN4 and the sixth compute node PN6. The sixth compute node PN6 is connected to the third compute node PN3, the fifth compute node PN5, and the I/O node ION. The seventh compute node PN7 is connected to the second compute node PN2 and the I/O node ION.

The I/O node ION is connected to the fourth compute node PN4, the sixth compute node PN6, the seventh compute node PN7, and the storage server STR.

Two compute nodes are connected by an interconnect. A compute node and the I/O node are connected by an interconnect. The I/O node ION and the storage server STR are connected by an interconnect. The connection provided by interconnects is represented by bold lines.

A compute node may access a different node or the storage server STR via another node. For example, the first compute node PN1 accesses the fifth compute node PN5 via the fourth compute node PN4. For example, the first compute node PN1 accesses the storage server STR via the fourth compute node PN4 and the I/O node ION.

The control node CN is connected to the I/O node ION and the compute nodes PN1 to PN7. The connection of the control node CN is connection passing through connection paths that are different from the connection paths using interconnects mentioned above. The connection of the control node CN is represented by dotted lines.

(Kernel Dumping)

If a failure has occurred for some reason in an operating system running with compute nodes, the operating system executes a process of restoration from the failure (also called as a recovery process). Note that this operating system is, for example, Linux (trademark). The operating system stops if the restoration process fails. That is, a failure stops the operating system. In general, in an operating system, particularly in a kernel, a state in which a failure has occurred for some reason and the operating system is not able to recover is called a kernel panic.

Upon occurrence of a kernel panic, another operating system that performs kernel dumping starts. Typically, an operating system that is run in regular operations is called a first kernel. An operating system that is launched after occurrence of a failure in the first kernel is called a secondary kernel, which is hereinafter referred to as a second kernel, when applicable.

Note that reasons why the second kernel, which is different from the first kernel, performs kernel dumping are the following two reasons.

The first reason is that even if, when a failure has occurred in the first kernel, the first kernel with the failure performs kernel dumping, it is not possible to ensure the accuracy of the kernel dumping.

The second reason is that, when the first kernel performs kernel dumping, the performed kernel dumping is likely to change the storage content of memory in which data related to the first kernel is loaded (also called an internal state of the kernel). If the internal state of the kernel is changed by the performed kernel dumping, an analyzer who analyzes the cause of the failure is not able to accurately determine the internal state of the kernel at the time at which the failure has occurred.

As described above, for the two reasons, the second kernel, which is different from the first kernel, performs kernel dumping.

In information processing (also called computing) for use in the field of high performance computing (HPC), the memory capacity per central processing unit (CPU) often affects the performance of information processing. In compute nodes, an increasingly large number of cores within one CPU have been being used in order to speed up information processing.

Although about eight cores per CPU are used in conventional compute nodes, a large number of cores, such as 128 cores, per CPU are used in the current compute nodes. Increasing the number of cores per CPU in such a manner indicates decreasing the memory area used per core.

In contrast, information processing that the user wants a compute node to perform has increased in scale. To perform large-scale information processing at high speed, memory mounted on a compute node has to have an increased capacity. Although the capacity of memory in a compute node has to be increased in such a manner, the increased capacity results in an actual situation in which the capacity (area) of memory assigned to one core is decreased.

However, for example, for the reason that increasing the memory capacity results in an increase in manufacturing cost, it is difficult to increase physical memories in proportion to the number of cores. To achieve the speed-up of information processing, an as large as possible area of memory in a compute node has to be assigned to jobs executed by the compute node.

However, as mentioned above, the area of memory to be used for the second kernel to run (second kernel area) is predetermined. The first kernel sets the second kernel area such that the second kernel area is not available for programs other than the second kernel. This setting puts a strain on the area of memory available for programs (for example, programs of the jobs mentioned above) other than the second kernel. That is, the second kernel puts a strain on the area of memory assigned to jobs executed by compute nodes.

The second kernel starts after a kernel panic. That is, the second kernel runs using the second kernel area only after the kernel panic. Thus, it is conceivable to reduce the kernel area in order to increase the area of memory assigned to jobs.

However, as the second kernel area becomes smaller, the area of memory used when the second kernel performs kernel dumping becomes likely to be insufficient. When the area of memory is insufficient, the second kernel frequently performs processing of collecting memory areas. If the second kernel frequently performs processing of collecting memory areas, the speed of kernel dumping, particularly the speed at which a result of kernel dumping is transferred, decreases. That is, reducing the second kernel area leads to a decrease in the speed at which kernel dumping is performed. Therefore, a compute node of the present embodiment enhances the speed at which kernel dumping is performed, while reducing the area of memory initially assigned to the second kernel.

(Hardware Block Diagram of Compute Node)

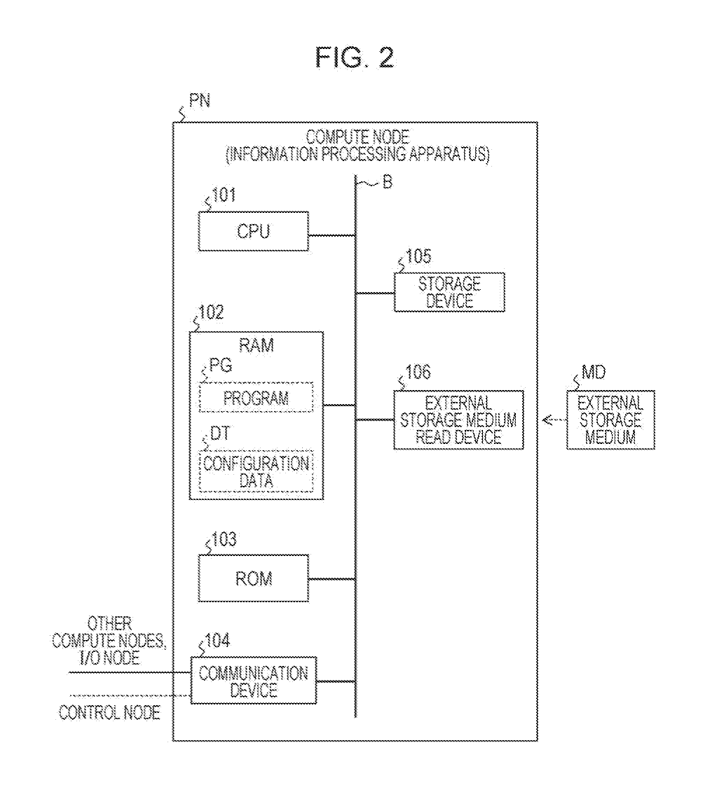

FIG. 2 is a hardware block diagram of a compute node of the present embodiment. Hereinafter, the compute node (information processing apparatus) PN in FIG. 2 is referred to as the compute node PN, when applicable. In FIG. 2, the hardware configuration of each of the compute nodes (PN1 to PN7) in FIG. 1 is illustrated.

The compute node PN includes a CPU 101, a RAM 102, a ROM 103, a communication device 104, a storage device 105, and an external storage medium read device 106. Note that RAM is an abbreviation for Random Access Memory and ROM for Read Only Memory.

The CPU 101 is a central processing unit that controls the entire compute node PN.

The RAM 102 is a storage device that temporarily stores data and so on created (computed) in processing executed by the CPU 101 and in each step executed by a program PG. The program PG is a program such as an operating system. The RAM 102 stores, for example, jobs submitted from the control node CN. The RAM 102 is semiconductor memory such as dynamic random access memory (DRAM). The RAM 102 also stores various kinds of data, for example, configuration data DT. RAM is also called memory.

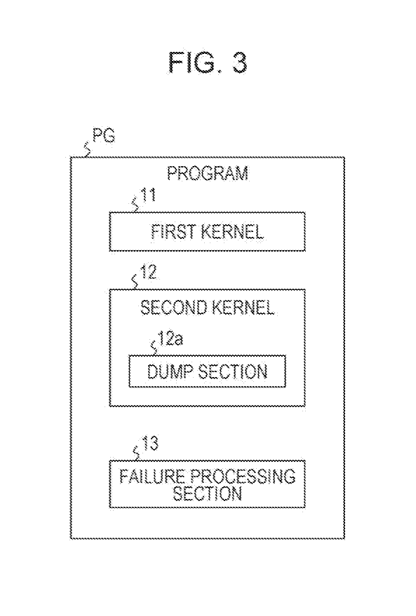

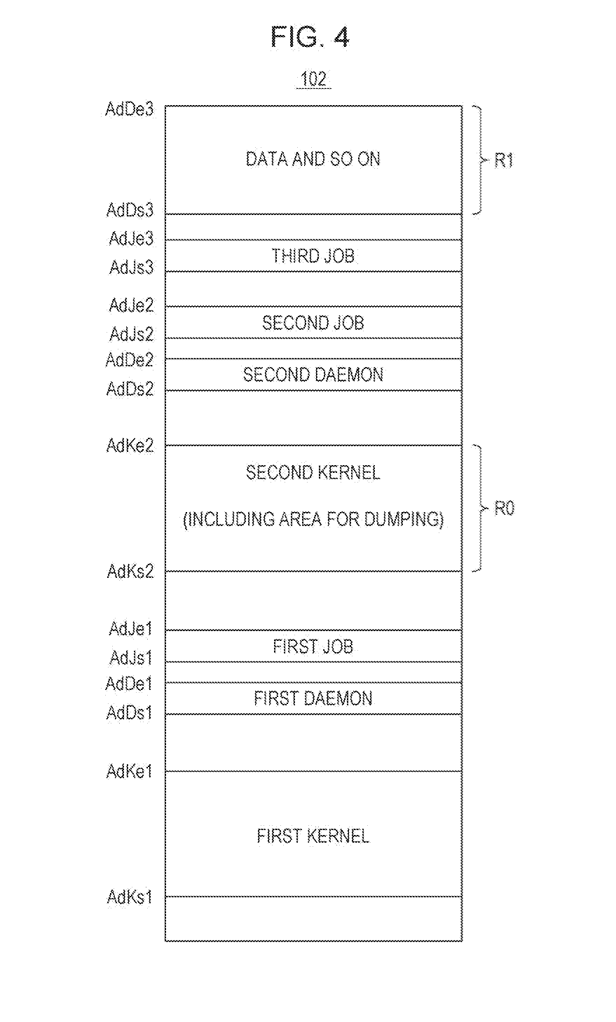

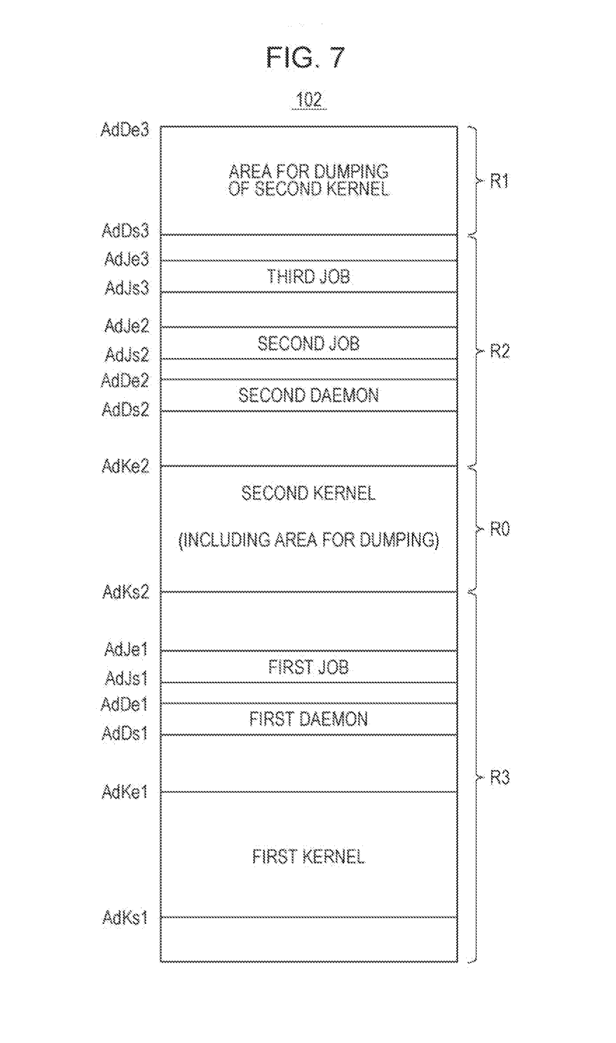

The CPU 101 is an example of a processing device that executes the first kernel (refer to FIG. 3) and, after occurrence of a failure in the first kernel, the second kernel (refer to FIG. 3), which outputs first data stored in the storage device (for example, the RAM 102) to another device. The other device is, for example, the storage server STR. The first data is, for example, data stored in a storage area other than a first storage area in the RAM 102. The first storage area is a storage area assigned to a second kernel 12, for example, an area for dumping included in an area R0 illustrated in FIG. 4 and FIG. 7 described below.

The ROM 103 stores various kinds of data. The communication device 104 is connected and communicates with other compute nodes and the I/O node ION (refer to FIG. 1) by interconnects. Further, the communication device 104 is connected and communicates with the control node CN via a connection path that is different from the connection path with interconnects. Note that the communication device 104, when connected to the control node CN via the Ethernet (trademark), includes, for example, a network interface card (NIC).

The storage device 105 is to store data such as, for example, a hard disk drive, a solid state drive, or nonvolatile semiconductor memory. The external storage medium read device 106 is a device that reads data stored in an external storage medium MD. The external storage medium MD is a nonvolatile storage medium, for example, a portable storage medium such as a compact disc read only memory (CD-ROM) or a digital versatile disc (DVD).

Executable files of the program PG are stored in the storage server STR (refer to FIG. 1). At the time of starting of the compute node PN, the CPU 101 reads executable files of the program PG from the storage server STR and loads them into the RAM 102. Such starting is also called a network boot. Note that, in the case where the compute node PN performs a network boot and further stores a result of kernel dumping described below in the storage server STR, the storage device 105 and the external storage medium read device 106 are unnecessary.

Note that executable files of the program PG may be stored, for example, in the storage device 105 and the external storage medium MD. At the time of starting of the compute node PN, the CPU 101 reads executable files from the storage device 105 and the external storage medium MD and loads the files into the RAM 102.

(Software Block Diagram)

FIG. 3 is a software block diagram for explaining the program PG in FIG. 2. The program PG includes a first kernel 11, the second kernel 12, and a failure processing section 13. The second kernel 12 includes a dump section 12a. The first kernel 11 is an operating system that is run in regular operations. The second kernel 12 is an operating system started after a failure has occurred in the first kernel 11. The dump section 12a of the second kernel 12 performs kernel dumping in which data stored in the RAM 102 is output to another device (for example, the storage server STR in FIG. 1).

The failure processing section 13 starts the second kernel 12 after a failure has occurred in the first kernel 11. When the operating system is Linux (trademark), the failure processing section 13 corresponds to a program module called, for example, kexec.

Note that the cause for the occurrence of a failure in the first kernel 11 is, for example, damage to hardware. There is another case where a management table of the RAM 102 managed by the first kernel 11 is destroyed for some reason. In addition, there is a case where data on a stack area managed by the first kernel 11 is destroyed.

(Memory Areas of RAM)

FIG. 4 is a first diagram schematically illustrating memory areas of the RAM 102 in FIG. 2. Character strings beginning with “Ad” attached to the left side of the RAM 102 schematically indicate addresses of the RAM 102. A memory area indicated by a start address AdKs1 to an end address AdKe1 is an area into which the first kernel 11 is loaded. Hereinafter, the memory area is referred to as an area, when applicable.

An area indicated by a start address AdDs1 to an end address AdDe1 is an area into which a first daemon is loaded. An area indicated by a start address AdJs1 to an end address AdJe1 is an area into which a first job is loaded.

An area indicated by a start address AdKs2 to an end address AdKe2 is an area into which the second kernel 12 is loaded. An area indicated by a start address AdDs2 to an end address AdDe2 is an area into which a second daemon is loaded. An area indicated by a start address AdJs2 to an end address AdJe2 is an area into which a second job is loaded.

A memory area indicated by a start address AdJs3 to an end address AdJe3 is an area into which a third job is loaded. An area indicated by a start address AdDs3 to an end address AdDe3 is an area into which various kinds of data are loaded.

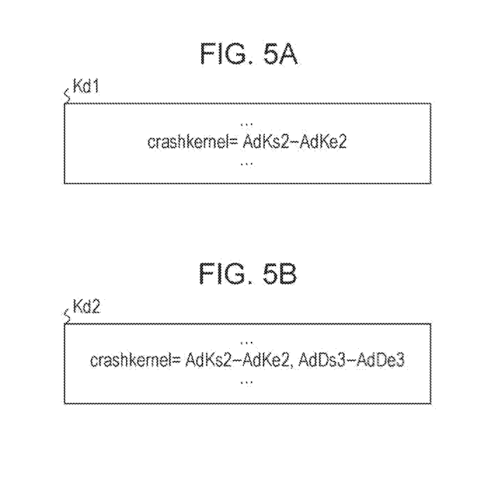

In FIG. 4, for areas other than those mentioned above, their description is omitted for the sake of simplifying description of kernel dumping. Note that reference letters R0 and R1 in FIG. 4 will be described with reference to FIGS. 5A and 5B.

(Configuration Files)

FIGS. 5A and 5B depict examples of configuration files including information of specifying areas of the RAM 102 that are available for the second kernel 12 in FIG. 3. FIG. 5A depicts a first configuration file Kd1 containing first information of specifying areas of the RAM 102 that are available for the second kernel 12. The first configuration file Kd1 contains “crashkernel=AdKs2-AdKe2” as the first information. The information “crashkernel=AdKs2-AdKe2” indicates that the second kernel 12 is able to use the area R0 of the RAM 102 (refer to FIG. 4). The area R0 is an area of the RAM 102 from the start address AdKs2 to the end address AdKe2 (refer to FIG. 4)

When the operating system is Linux (trademark), the first configuration file Kd1 is a file “kdump” stored, for example, in a folder “sysconfig” directly under a folder “etc” in a file system. Note that the first configuration file Kd1 may be another file other than the file “kdump”.

FIG. 5B depicts a second configuration file Kd2 containing second information of specifying areas of the RAM 102 that are available for the second kernel 12. The second configuration file Kd2 contains “crashkernel=AdKs2-AdKe2, AdDs3-AdDe3” as second information. The information “crashkernel=AdKs2-AdKe2, AdDs3-AdDe3” indicates that the second kernel 12 is able to use the area R0 and the first area R1 (refer to FIG. 4). The first area is an area of the RAM 102 from the start address AdDs3 to the end address AdDe3 (refer to FIG. 4).

The second configuration file Kd2 is a file stored, for example, in the folder “sysconfig” directly under the folder “etc” in the file system, when the operating system is Linux (trademark). Developers and the administrator of the information processing system SYS create the first configuration file Kd1 and the second configuration file Kd2.

(Starting of Operating System, Execution of Jobs)

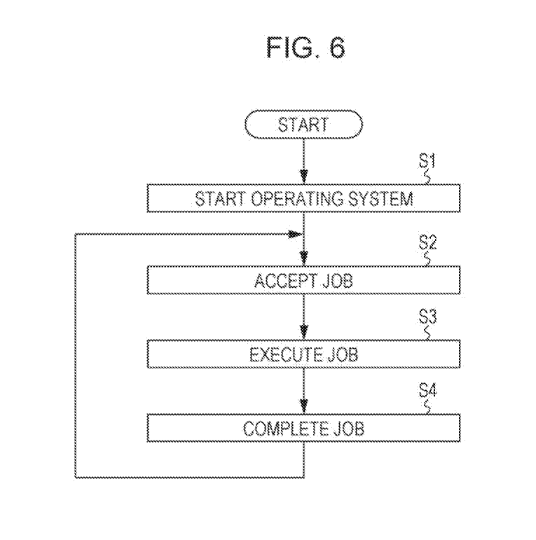

FIG. 6 is a flow diagram illustrating starting of an operating system and execution of jobs. A compute node that performs each step illustrated in the flow diagram in FIG. 6 is assumed as, for example, the sixth compute node PN6 in FIG. 1. Note that the compute node that performs each step illustrated in the flow diagram in FIG. 6 may be a compute node other than the sixth compute node PN6.

Step S1: The first kernel 11 starts. Specifically, upon receiving a startup command from the control node CN, the CPU 101 of the sixth compute node PN6 reads executable files of a startup program and various files stored in the ROM 103 and loads the read files into the RAM 102. The startup program executes a network boot described with reference to FIG. 2 to read executable files of the program PG stored in the storage server STR and load the read files into the RAM 102.

The executable files of the program PG include image files of the first kernel 11, image files of the second kernel 12, and so on.

Various configuration files include area files containing information indicating memory areas where the first kernel 11 and the second kernel 12 run and reference files suitably referred to during running of the first kernel 11 and the second kernel 12. The area files containing information indicating memory areas where the second kernel 12 runs are, for example, the first configuration file Kd1 in FIG. 5A and the second configuration file Kd2 in FIG. 5B.

Image files of the first kernel 11 include a dump target area file. The dump target area file is a file containing information indicating memory areas of the RAM 102 that are to be subjected to kernel dumping performed by the second kernel 12.

Note that the image files of the first kernel 11 may include various configuration files.

Step S2: The first kernel 11 accepts a job submitted by the control node CN and assigns, to the job, an area of the RAM 102 to be used when the job is executed. For example, when the first kernel 11 accepts the first job submitted by the control node CN, the first kernel 11 assigns an area of the RAM 102 (the area indicated by the start address AdJs1 to the end address AdJe1), which is to be used when the first job is executed, to the first job.

Step S3: The CPU 101 executes the job accepted in step S2. Specifically, the CPU 101 executes the first job, using the area assigned to the job accepted in step S2. The first job outputs an execution result.

Step S4: Execution of the job in step S3 is completed. Upon completion of execution of the job, the first kernel 11 proceeds to a job completion mode to perform processing of deleting a file created by execution of this job and processing of freeing the area of the RAM 102 assigned to the job. Subsequently, the first kernel 11 proceeds to step S2, where the first kernel accepts a job again.

Note that, after starting, the first kernel 11 sometimes executes one or more daemons (also called resident programs). The daemons are a daemon for node management, a daemon for job management, and a clone daemon. Note that the clone daemon is a program that automatically executes commands and shell scripts based on a schedule set in advance.

For example, the first kernel 11 executes the first daemon, using an area indicated by the start address AdDs1 to the end address AdDe1 in the RAM 102.

At the time of starting (step S1), the first kernel 11 determines the area R0 (the area indicated by the start address AdKs1 to the end address AdKe1) of the RAM 102, as an area for the second kernel 12, based on the first configuration file Kd1.

The first kernel 11 then sets the area R0 so that the area R0 is not available for programs (for example, programs of the accepted job and daemons) other than the second kernel 12. The first kernel 11 then loads the second kernel 12 into the area R0. From that point on, the second kernel 12 uses the area R0 as a RAM disk area containing a group of requisite commands called initramfs, a work area for the second kernel 12 to run, or an area for dumping used for performing kernel dumping. In the loading mentioned above, the first kernel 11 loads the second configuration file Kd2 in FIG. 5B into the area R0. Note that the state in which the second configuration file Kd2 in FIG. 5B, for example, is loaded is schematically illustrated as the configuration data DT in FIG. 2.

(Occurrence of Failure)

As described with reference to FIG. 3, a failure occurs in the first kernel 11 for some reason. Upon the occurrence, the failure processing section 13 starts the second kernel 12. After the starting, the second kernel 12 performs kernel dumping. In the kernel dumping, the second kernel 12 outputs memory areas other than the area R0 for the second kernel 12 to another device (for example, the storage server STR in FIG. 1).

(Kernel Dumping)

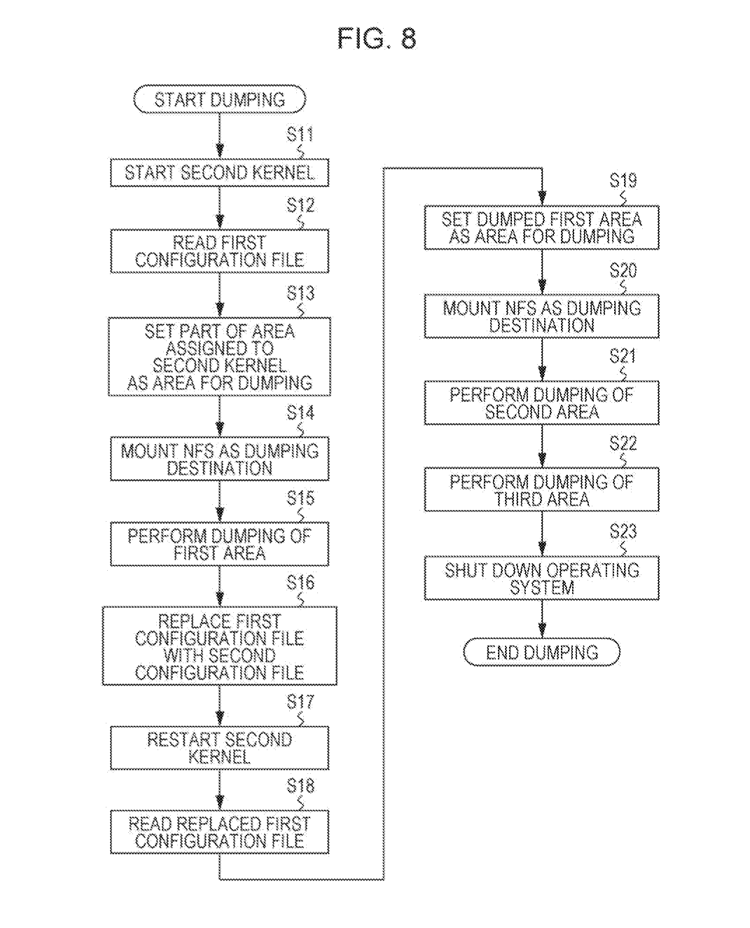

Next, with reference to FIG. 1 to FIG. 8, kernel dumping in the present embodiment will be described. FIG. 7 is a second diagram schematically illustrating memory areas of the RAM 102 in FIG. 2. FIG. 7 is a diagram obtained by changing part of the diagram of FIG. 4. FIG. 8 is a flow diagram for explaining kernel dumping in the present embodiment. With reference to FIG. 8, kernel dumping in the present embodiment will be described.

Step S11: The second kernel 12 starts. Specifically, once a failure occurs in the first kernel 11, the failure processing section 13 responds to this failure to start the second kernel 12, using the area R0 of the RAM 102.

Note that, for cases where the operating system is Linux, the second kernel 12 started has a device file “/dev/oldmem”.

Step S12: The second kernel 12 reads the first configuration file Kd1 depicted in FIG. 5A.

Step S13: The second kernel 12 determines part of the area R0 assigned to the second kernel 12, as an area for dumping used for performing kernel dumping. Using the area for dumping, the second kernel 12 executes various processes for performing kernel dumping.

Step S14: The second kernel 12 mounts a network file system (NFS) as the dumping destination.

Specifically, the second kernel 12 mounts the storage server STR (refer to FIG. 1), which is connected to the I/O node ION (refer to FIG. 1), included in the network file system. This mounting enables the second kernel 12 to access the storage server STR. Note that the storage server STR is mounted on the I/O node ION in advance.

Step S15: The second kernel 12 performs kernel dumping of the first area R1 (refer to FIG. 4). Specifically, the second kernel 12 refers to the dump target area file and accesses a memory area to be dumped. The memory area to be dumped is an area in which data on which kernel dumpling has not yet been performed is stored. The dump target area file contains, for example, the start address and the end address of the first area R1 in FIG. 4, the start address and the end address of the second area R2 in FIG. 7, and the start address and the end address of a third area R3 in FIG. 7, in that order.

The second kernel 12 then copies data in the accessed memory area into the area for dumping of the area R0 and performs given processing on the copied data. As an example of the given processing, there is information processing through which the copied data is translated into an executable and linkable format (ELF).

The second kernel 12 outputs the data on which information processing is performed, to the mounted storage server STR (refer to FIG. 1) (kernel dumping).

When the second kernel 12 performs kernel dumping, the speed at which the kernel dumping is performed is increased in proportion to the size of the area for dumping. This is because, if the area for dumping is larger, the amount of data that may be copied at a time is larger and the memory area to be used for performing given processing is also larger.

Therefore, it is considered to use a dumped memory area (the region R1 in the case mentioned above) as an area for dumping.

Note that the second kernel 12 performs kernel dumping in areas in the order of the addresses of the areas contained in the dump target area file. For example, when the start address and the end address of each area are contained in the order mentioned above in the dump target area file, the second kernel 12 performs kernel dumping on data stored in each memory area in the order of the first area R1, the second area R2, and the third area R3.

Once kernel dumping on data stored in one memory area is completed, the second kernel 12 proceeds to the next step S16. For example, upon completion of kernel dumping of one memory area, the first area R1, contained in the dump target area file, the second kernel 12 proceeds to the next step S16.

Step S16: Once kernel dumping of the first area R1 is completed, the second kernel 12 replaces the first configuration file Kd1 (refer to FIG. 5A) with the second configuration file Kd2 (refer to FIG. 5B). That is, the second kernel 12 overwrites the first configuration file Kd1 with the second configuration file Kd2.

For cases where the operating system is Linux (trademark), the second kernel 12 executes a command “my/etc/sysconfig/kdump.2nd /etc/sysconfig/kdump”.

Through the process in step S16, the first configuration file Kd1 becomes the second configuration file Kd2.

Step S17: The second kernel 12 restarts.

Specifically, once the process in step S12 is completed, the second kernel 12 notifies the failure processing section 13 of that completion. The failure processing section 13 responds to the notification to restart the second kernel 12.

Step S18: The second kernel 12 reads the replaced first configuration file. Specifically, the second kernel 12 reads the second configuration file Kd2 in FIG. 5B.

Step S19: The second kernel 12 sets, in addition to the area for dumping determined in step S13, a dumped memory area as an area for dumping.

Specifically, the second kernel 12 identifies the second information “crashkernel=AdKs2-AdKe2, AdDs3-AdDe3” contained in the replaced first configuration file (in other words, the second configuration file Kd2 in FIG. 5B).

The second kernel 12 then identifies an area other than the memory area (“AdKs2-AdKe2” described with reference to FIGS. 5A and 5B) identified by the first information, included in the identified second information. The second kernel 12 identifies an area indicated by addresses “AdDs3-AdDe3”. The identified area, which is the first area R1 in FIG. 4, is a dumped area. Since data to be used for analysis of the occurrence of a failure is already not stored in a dumped area, the second kernel 12 uses that dumped area as an area for dumping.

The second kernel 12 then sets the identified area (for example, the first area R1) as an area for dumping. The state in which the first area R1 is set as an area for dumping is illustrated in FIG. 7. FIG. 7 schematically illustrates the state in which the first area R1 is set as an area for dumping of the second kernel 12 by the second kernel 12 (refer to “area for dumping of second kernel”).

Note that the start address and the end address of the first area (the first area R1) stored in the RAM 102 are stored in the second configuration file Kd2 in FIG. 5B.

Step S20: The second kernel 12 mounts the network file system as the dumping destination. The process in step S20 is the same as that in step S14 and its description is omitted.

Step S21: The second kernel 12 performs kernel dumping of the second area R2 (refer to FIG. 7). The second area R2 is, for example, an area in which data on the second daemon, the second job, and the third job is loaded.

Specifically, the second kernel 12 refers to the dump target area file and accesses the second area R2, which is a memory area to be dumped.

The second kernel 12 copies the data in the accessed memory area into the area for dumping in the area R0 and into the first area R1 and performs given processing on the copied data. The second kernel 12 outputs the data on which information processing is performed, to the mounted storage server STR (refer to FIG. 1).

Step S22: The second kernel 12 performs kernel dumping of the third area R3 (refer to FIG. 7). The third area R3 is, for example, an area in which data on the first kernel 11, the first daemon, and the first job is loaded.

Specifically, the second kernel 12 refers to the dump target area file and accesses the third area R3, which is a memory area to be dumped.

The second kernel 12 copies data in the accessed memory area into the area for dumping in the area R0 and into the first area R1 and performs given processing on the copied data. The second kernel 12 outputs the data on which information processing is performed, to the mounted storage server STR (refer to FIG. 1) (kernel dumping).

In steps S21 and S22, the second kernel 12 is able to perform kernel dumping, using the area R0 and the first area R1. That is, the total areas for dumping used by the second kernel 12 in steps S21 and S22 is larger than the area for dumping used by the second kernel 12 in step S15. Consequently, the second kernel 12 may cause the speed at which kernel dumping is performed in steps S22 and S23 to be higher than the speed at which kernel dumping is performed in step S15.

Step S23: After completion of kernel dumping, the second kernel 12 powers off the information processing apparatus that runs the second kernel 12 to shut down the operating system.

As described above, using the first storage area (also called a memory area) in the RAM 102, the second kernel 12 outputs second data stored in a second memory area in the RAM 102 to the storage server STR. The first memory area is a storage area assigned to the second kernel 12, for example, the area for dumping included in the area R0 illustrated in FIG. 4 and FIG. 7. The second memory area is, for example, the area R1 illustrated in FIG. 4 and FIG. 7.

After this outputting, using the first memory area and the second memory area, the second kernel 12 outputs third data stored in a third memory area in the RAM 102 to the storage server STR. The third memory area is, for example, the area R2 in FIG. 7.

In using the first memory area, the second kernel 12 refers to area information indicating the second memory area and the third memory area. This area information is, for example, information contained in the dump target area file, which is described in step S15 in FIG. 8. The dump target area file contains, for example, the start address and the end address of the first area R1 in FIG. 4, the start address and the end address of the second area R2 in FIG. 7, and the start address and the end address of the third area R3 in FIG. 7.

The second kernel 12 accesses the second memory area by referring to this area information and copies the second data stored in the second memory area into the first memory area. The second kernel 12 performs given processing on the copied second data and outputs the second data on which the given processing is performed, to the storage server STR.

After outputting, in using the first memory area and the second memory area mentioned above, the second kernel 12 refers to this area information and accesses the third memory area. Then, the second kernel 12 copies the third data stored in the third memory area into the first memory area and the second memory area. The second kernel 12 then performs given processing on the copied third data and outputs the third data on which the given processing is performed, to the storage server STR.

As described above, in the information processing apparatus described in the present embodiment, the memory area initially assigned to the second kernel is small. Consequently, memory areas assigned to the programs other than the second kernel may be set large.

The information processing apparatus described in the present embodiment initially assigns a small area to the second kernel but, at the time of kernel dumpling, uses a dumped area as an area for dumping. That is, the information processing apparatus described in the present embodiment increases the total amount of areas for dumping as the kernel dumping progresses. As a result, it is possible to enhance the speed at which kernel dumping is performed.

As described above, according to the information processing apparatus of the present embodiment, the speed at which kernel dumping is performed may be enhanced while the memory area initially assigned to the second kernel is reduced.

Note that although, after the occurrence of a kernel panic, the second kernel might be started in such a way that a new memory area for the second kernel is secured and assigned to the second kernel, it is not possible to employ such a method of starting the second kernel. The reason for this will be discussed. When the first kernel secures a new memory area and assigns it to a program, the first kernel assigns the memory area based on a request from the program. However, once a kernel panic has occurred, the first kernel is not able to detect where a continuous memory area for assignment to the program is located within memory. For this reason, it is not possible for the first kernel to secure a new memory area for the second kernel and to assign the memory area to the second kernel. Thus, it is not possible to employ the above method of starting the second kernel.

Note that the first configuration file Kd1 replaced in step S16, which is loaded in the RAM 102, is lost when the power is turned off. Information contained in the first configuration file Kd1 replaced in step S16 is information contained in the second configuration file Kd2. Since the replaced first configuration file Kd1 is lost in this way, the first configuration file Kd1 before replacement is read in step S12 when the power is turned on next and the second kernel 12 is started.

(Modification)

Next, a modification of the present embodiment will be described. Each time kernel dumping of an area is completed, the second kernel 12 may use that area, where the kernel dumping is complete, as an area for dumping. For example, after performing kernel dumpling of the second area R2 (refer to FIG. 7) (step S21), the second kernel 12 may use the second area as an area for dumping. Each time kernel dumping of an area is completed, the second kernel 12 uses that area, where the kernel dumping is complete, as an area for dumping, and thus the total amount of areas for dumping gradually increases. For example, the total amount of areas for dumping increases gradually, 128 kilobyte, 1 megabyte, and 10 megabyte. The larger the total amount of areas for dumping is in such a manner, the higher the speed at which kernel dumping is performed is.

Additionally, the memory area to be dumped may be arbitrarily set. For example, in the above description, the second kernel 12 first dumps data of the first area R1, which is apart from the area R0, in the RAM 102 in FIG. 7.

However, the second kernel 12 may first dump the second area R2 or the third area R3 adjacent to the area R0. In particular, the second kernel 12 may first dump data of an area adjacent to an area for dumping in the area R0. In such a way, the second kernel 12 may secure an area for dumping with successive addresses by first performing kernel dumping on data of an area adjacent to the area R0.

When an area for dumping with successive addresses may be secured, the memory access time may be reduced. The second kernel 12 may reduce the memory access time and thus may enhance the speed at which kernel dumping is performed.

Additionally, the information processing apparatus of the present embodiment may dynamically create the second configuration file Kd2. For example, upon completion of kernel dumping on data stored in an area contained in the dump target area file, the failure processing section 13 stores the start address and the end address of the area, where the kernel dumping is complete, in the second configuration file Kd2. In the examples in FIGS. 5A and 5B, the failure processing section 13 stores the start address and the end address of the area, where kernel dumping is complete, at locations after “crashkernel=”.

Additionally, the information processing apparatus of the present embodiment restarts the second kernel 12 and sets a dumped area as an area for dumping. However, without restarting the second kernel 12, a dumped area may be dynamically set as an area for dumping.

In this setting, the second kernel 12 stores memory addresses indicating a dumped area in the area R0. Then, the second kernel 12 dynamically sets the area indicated by the memory addresses in the area R0, as an area for dumping. When setting a dumped area as an area for dumping, the second kernel 12 sets the dumped area to be readable and writable (so-called read-write is possible).

Additionally, the information processing apparatus of the present embodiment reads the first configuration file Kd1 at the time of starting of the second kernel 12 and specifies an area of the RAM 102 available for the second kernel 12. However, the failure processing section 13, at the time of starting the second kernel 12, may input arguments indicating an area of the RAM 102 available for the second kernel 12 to the second kernel 12. The second kernel identifies the area of the RAM 102 available for the second kernel 12, based on the input arguments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus, comprising:
a storage device; and
a processing unit coupled to the storage device and configured to:
execute a first kernel and, after occurrence of a failure in the first kernel, a second kernel to output a kernel dump of first data stored in the storage device to another device; and
through the second kernel, using a first storage area in the storage device, output a kernel dump of second data stored in a second storage area in the storage device to the other device, and then, using the first storage area and the second storage area, output a kernel dump of third data stored in a third storage area in the storage device to the other device.

2. The information processing apparatus according to claim 1,
wherein the second kernel, in using the first storage area, refers to area information indicating the second storage area and the third storage area, accesses the second storage area, copies the second data stored in the second storage area into the first storage area, performs given processing on the copied second data, and outputs, to the other device, a kernel dump of the second data on which the given processing is performed.

3. The information processing apparatus according to claim 1,
wherein the first storage area is a storage area assigned to the second kernel, and
wherein the first data is data stored in a storage area other than the first storage area.

4. The information processing apparatus according to claim 2,
wherein the second kernel is, in using the first storage area and the second storage area, after outputting the kernel dump of the second data on which the given processing is performed, refers to the area information, accesses the third storage area, copies the third data stored in the third storage area into the first storage area and the second storage area, performs given processing on the copied third data, and outputs, to the other device, a kernel dump of the third data on which the given processing is performed.

5. A kernel dump method executed in an information processing apparatus including a storage device and a processing device, the processing device being configured to execute a first kernel and, after occurrence of a failure in the first kernel, a second kernel configured to output a kernel dump of first data stored in the storage device to another device,
after the occurrence of a failure in the first kernel, start the second kernel and, using a first storage area in the storage device, outputting a kernel dump of data stored in a second storage area in the storage device to the other device; and
outputting, using the first storage area and the second storage area, a kernel dump of data stored in a third storage area in the storage device to the other device.

6. A non-transitory, computer-readable recording medium having stored therein a kernel dump program that, when executed by a computer, causes the computer to execute a process, the process comprising:
after occurrence of a failure in a kernel, outputting, using a first storage area in a storage device, a kernel dump of data stored in a second storage area in the storage device to another device; and
outputting, using the first storage area and the second storage area, a kernel dump of data stored in a third storage area in the storage device to the other device.
